(19) United States
(12) Patent Application Publication
(10) Pub. No.: US 2014/0379437 A1
(43) Pub. Date: Dec. 25, 2014

(54) Computer Enabled Enterprise Business Monitoring System

(71) Applicant: Raminder Singh, Poway, CA (US)

(72) Inventor: Raminder Singh, Poway, CA (US)

(21) Appl. No.: 14/313,843

(22) Filed: Jun. 24, 2014

Related U.S. Application Data
(60) Provisional application No. 61/838,837, filed on Jun. 24, 2013.

(51) Int. Cl. G06Q 10/06; G06F 3/0486; G06F 3/0482; G06F 3/0484

(52) U.S. Cl. CPC G06Q 10/06393; G06F 3/04842; G06F 3/0486; G06F 3/0482
USPC 705/7.39

(57) ABSTRACT

A networked graphical user interface for creating, manipulating and displaying depictions of user chosen data is provided. The graphic interface communicated to a user display in a radial positioning provides a plurality of individual depictions allowing user choices to initiate a data communication to said user device, or to initiate secondary depictions relating to one or a plurality of sub choices available to said user, using a pointing device. Secondary graphic interfaces provide grid selection and positioning for visual renditions of data communicated per user choice.

This application is a Nonprovisional application based on U.S. Provisional Application No. 61/838,837 filed on Jun. 24, 2013, which is included herein in its entirety.

### BACKGROUND OF THE INVENTION

1. Field of the Invention

The present invention relates to business management and monitoring. More particularly, it relates to a computer enabled wide area network-accessible software-implemented management system for business. The system enables users such as company executives and managers to view critical business metrics or key performance indicators (KPI) relative to the individual user's span of control, through a network-communicated displayed dashboard depicted on a user display. So enabled, users employing the disclosed dashboard-enabled measure oriented semantic data model herein, are provided with the ability to move and mix business data graphically using the novel features of the dashboard interface.

2. Prior Art

Network accessible computer enabled business management and enterprise software driven systems and methods exist for users to access business data and information from remote and local locations. However, most such systems simply provide the user simple data concerning ongoing business operations. In order to use such data for predictive analysis and planning, many users must move the data into spreadsheets and the like which is problematic.

Further, even if the data is communicated and employable within such spreadsheets, such do not always provide the ability to review or depict multiple performance indicators and the like to enable the user to easily construct business planning scenarios which are objective and fact-driven. Still further, such systems do not adequately provide a graphic depiction on the user's viewing screen on a PC, pad, or smartphone, which reasonably depicts or represents, choices for communicated data concerning the business scenario being researched or planned, in a manner related to the real world.

Operational system integration based on information-oriented architecture, in the context of semantic model includes the employment of a semantic model as the functional core of the system to provide users a navigable model of data and associated relationships which includes the data or knowledge in the target domain. As defined by the World Wide Web Consortium (W3C), the Semantic Web “provides a common framework that allows data to be shared and reused across application, enterprise, and community boundaries.” While the web had generally been about the ability to share documents, a Semantic Web provides the framework so that machines can share, interrogate more readily, and understand data. Conventionally, a semantic web is configured to support common formats for data that a variety of different sources can present or depict. It also provides a structure for understanding the data relationships. A selenic web is conventionally enabled with software to implement and support the interrogation of web based data from users, relying on a semantic meaning rather than on explicit (or implicit) links and references.

Semantic models thus allow users to make an inquiry about gathered and stored data in a modeled system in a more natural way. As an example, an accounting system for sales and invoicing can include data concerning sales in regions, customer payments, timing of payments, payments to vendors, open invoices and closed invoices, and numerous other gathered data points concerning cash flow and sales and purchasing.

Further, different users may have differing levels of access to the differing types of data stored in various databases. A user with appropriate access rights may wish to discern the amount of sales in a particular region of a country, and for instance with regard to open invoices for such sales, an aging of the invoices.

A semantic model will allow a user to make an inquiry such as “what are the sales in area A, in the last 90 days and of the open invoices, on such, how many are paid, and unpaid.” With appropriate software, the user need not understand details such as which specific database maintains the real time information which is being provided, or the format thereof, and need not know how to interface the software on their local computing device, with that on the remote server or computer providing the requested information.

However, currently the conventional interfaces provided for users for such an inquiry, are fashioned on the manner of data retrieval for prior art systems where the user is conventionally required to download only data from a known point and operatively included it in a spreadsheet, along with other data downloaded and inquired about separately, and process the downloaded data locally to attempt to discern the answer to the question they seek.

As such, there is a continuing unmet need for an improved network accessible business management system, having a graphic interface or dashboard and underlying graphic interface screens, enabling users accessing it through computing systems, smartphones or pad computers, to more naturally and easily view and request critical business metrics for their business or their respective department of a business. Such a system should provide an interface adapted to provide the most clickable choices to the user during use, in the smallest amount of space on a video display, since modern computing as evolved to users with smartphones and pad computers with smaller screens. Such a system should provide drill-down options and review key of performance indicators, relative to the user respective span of control or authorization level. Such a system should provide remotely viewable screens in order that users are provided a conceptual data model in which semantic information is included.

Still further, to obviate the shortcomings of the current art, such a system should provide interactive graphic interfaces which provide the user a semantic data model in an abstraction which defines how the representational graphics depicted on their display as related to their business, relates to the real world. Such a system should provide such information and interaction through the employment of an intuitive user interface which when displayed remotely on the user's screen, provides an intuitive dashboard graphic interface system. Such a system should not only provide user access to data and a semantic model based thereon, such a system should provide users the ability to move and mix business data graphically for planning and review, and conceptualizing business scenarios through the employment the dashboard interface.

### SUMMARY OF THE INVENTION

The method and system herein disclosed and described provides a solution to the shortcomings in prior art, and achieves the above noted goals through the provision a computer enabled software system yielding a directed business intelligence-based enterprise performance monitoring system. The system enabled by software running on a computer with network communication access, allows users such as business executives and managers, to access business data and information over a network in a manner more natural.

Using an intuitive graphical interface, displayed on the user's display screen, the system enables company executives and managers to view critical metrics or data concerning desired key performance indicators, for their respective area of concern or management responsibility. The graphics feature a plurality of interrelated graphic interface screens, which sequentially allow the user to select specific data of concern, or for planning purposes, and thereby generate one or a plurality of views of different business scenarios or events. Such can be depicted as occurring in real time, or in future predicted scenarios based on prior stored data and information employable by the predictive software.

Employing the graphic interfaces and associated data and predictive analysis, the system enables executives and managers running an organization to more effectively and efficiently generate or review a current strategy, or to calculate a future strategy. Thereafter using the system herein and the interrelated graphic interfaces, such users may execute on each strategy to thereby improve their respective business processes and continue to review and manage key company metrics probatively.

Employing the software for the system herein adapted to run on computing devices and generate graphic interfaces for interaction with the remote user, the system provides users a means for viewing data from multiple data sources and source types on a single communicated user interface depicted on the local display of the user. So depicted, the system enables the user to interact using the graphic interface and to be able to view different business events within their organization as they are unfolding in real time.

The system is also well configured to enable users to retrieve data for analyzing such to seek and discover hidden trends. This data mining for trends is enhanced from conventional means through the provision of powerful visualization features in the form of graphic interfaces which provide the user an objective view of current and future scenarios based on a high number of user choosable depictions or icons depicted in a radial depiction from a central point on the display. By providing interfaces for seeking trends based on past data, the system also enables business leaders to model predictive business scenarios using such trends and thereby make future projections.

The system herein employs innovative measure oriented semantic data model for predictive modeling using current and past key performance indicators of the company which may be objectified using industry norms. The system using user friendly and intuitive graphical interface screens provides easy access over a local network or a wide area network such as the internet. As such the system is especially well adapted for employment over the web, from a cloud based server or system, and from and too mobile computing devices such as smartphones or pad computers.

In a preferred mode of the system, it employs an intuitive graphic user interface, and provides a graphic interactive depiction of chosen key performance indicator data in a graphical format. Employing this interface, users may simply drag and drop elements from depicted charts or renderings of key performance indicators, to construct predictions and plans for the business.

Especially preferred in the system, is the provision of software enabled capability for users to access all the system's interactive features through an innovative radial menu graphic interface design. This radial menu graphic interface is communicated to be substantially centered on the user's display to provide a large plurality of choices as to data requests. It thus optimizes the system to allow the user a plurality of drilldown options, by showing the values in an ordered scenario based on the user's usage patterns and previous request. This minimizes the video screen required for such display which is especially important with smartphone and pad computers which employ smaller screen configurations.

The system, employing a measure-oriented semantic data model, communicates a graphic interface accessed tool to the display of the user device, enabling the creation of dynamic relationships between data and key predictive indicators. These relationships are inferred dynamically during chart creation which provides the system a means for displaying additional drilldown options, which may not be explicitly defined within the data structure. Such a graphic interface software enabled method allows for virtual measures i.e. measures that are transformations/aggregates etc. based upon more granular measures. This additionally results in small data packet size than conventional spreadsheet and other systems thereby rendering the system easier and faster to operate over the data-constricting confines of a network and/or the internet.

Another preferred system operation is the employment of a common caching mechanism between key predictive indicators and the object models for the key predictive indicators since the object model is well defined based on relations between measures. Further, most system provided drilldowns or data filters can be explicitly expressed as relations between measures.

Yet another preferred mode in the system herein, is the provision of the intuitive graphic interface to the user as a tool to retrieve unstructured data and thereafter render meaningful charts and depictions thereof through dynamically inferred relationships. Such graphical expression enables the user more easily interpret meaning (semantics) and more easily discern the relationships of such data.

The system preferably is provided with inbuilt generic data connectors and handles that can connect and employ different data source type formats. Such data sources include but are not limited to relational databases, spreadsheets, flat files, XML tags and web services. These generic connectors also have provide capability to retrieve data.

The measure-oriented semantic data model provided by the graphic interface method and system herein, provides a significant enhancement to the art, through the easy creation of dynamic relationships within the retrieved data. Such are, with the system herein, inferred dynamically during chart creation for depiction on the user's screen. Further, the system enables the displayed charts, to display additional drilldown options, which are not explicitly defined within the data structure itself. As noted, this mode of system operation thereby allows virtual measures i.e. measures that are transforms/aggregates etc. on more granular measures, resulting in toe noted small data size.

With respect to the above description, before explaining at least one preferred embodiment of the software and computer enabled networked system and method herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other systems and methods and systems for carrying out the several purposes of the present disclosed system and method. It is important, therefore, that the claims be regarded as including such equivalent construction and methodology insofar as they do not depart from the spirit and scope of the present invention.

It is an object of the invention to provide a software enabled measure-oriented semantic data modeling system providing users with the ability to move and mix business data graphically using a unique dashboard interface system for provision of a network-accessible business intelligence-based enterprise performance monitoring system.

It is a further object of this invention to provide such modeling system through the provision of remotely depicted dashboard interface allowing the user to generate graphically depicted Key Product Indicators using a measure oriented semantic data model enabled by the system and dashboard provided.

It is a further object of this invention to provide such a system, which communicates to the user device, easy and intuitive graphic interfaces in a radial depiction, thereby maximizing user choices on the remote display and enhancing choices for system employment.

These together with other objects and advantages which become subsequently apparent reside in the details of the construction and operation of the measure-oriented semantic data modeling system enabling the method herein as more fully hereinafter described and claimed, reference being had to the accompanying drawings forming a part thereof, wherein like numerals refer to like parts throughout.

### BRIEF DESCRIPTION OF DRAWING FIGURES

FIG. 1 shows an example of a system-generated dashboard graphic interface communicable to a user display, allowing the user to depict key performance indicators thereon.

FIG. 2 depicts the preferred radial menu of the system allowing the user multiple drill-down or additional data choices.

FIG. 3 depicts the drill down options of the preferred radial menu system provided in radial format.

FIG. 3a is a graphic depiction of the preferred radially depicted graphic interface providing the user the substantial number of user choices presentable in such a radial graphic format.

FIG. 4 shows a grid style view communicated based on a choice from the radially presented interface.

FIG. 5 depicts a grid creation graphic interface allowing the user to choose the number of positions for chosen information from the radial interface for display therein.

FIG. 6 shows a resulting grid created using the a chosen grid from FIG. 5 and communicated data from the radially depicted interface of FIGS. 3 and 3a.

### DETAILED DESCRIPTION OF THE PREFERRED EMBODIMENTS OF THE INVENTION

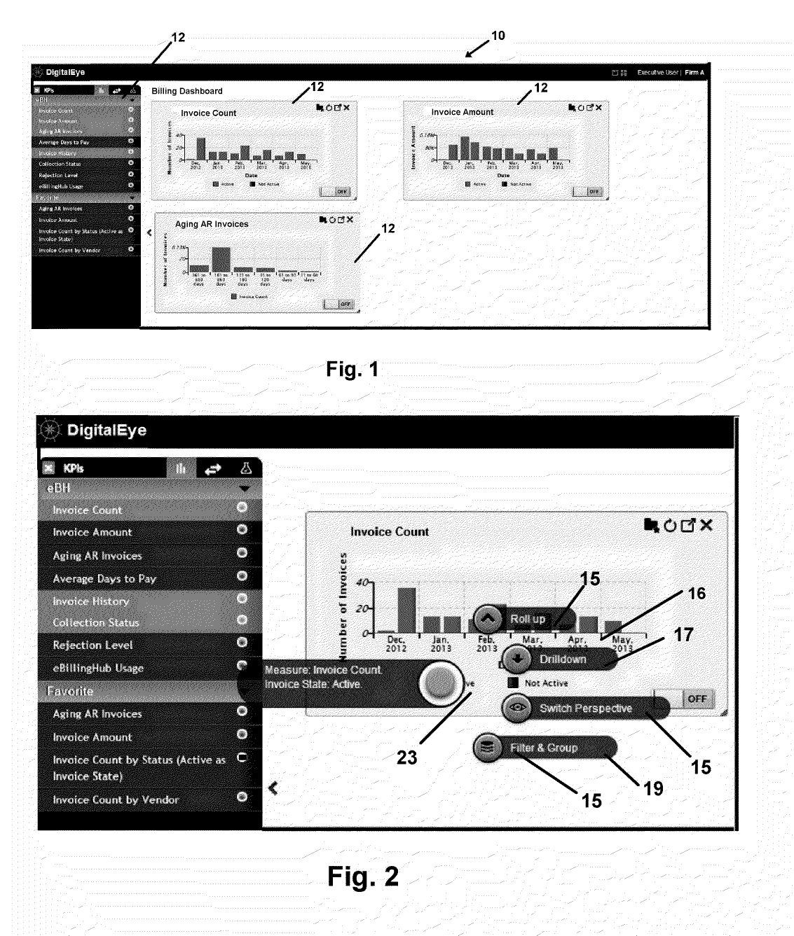

In a preferred mode of the system, and the depictions in FIGS. 1-6 there is seen in FIG. 1 an example of the system 10 generated dashboard graphic interface which depicts key performance indicators 12 shown in columns and depicted on a user display using retrieved data in a chosen boxed grid.

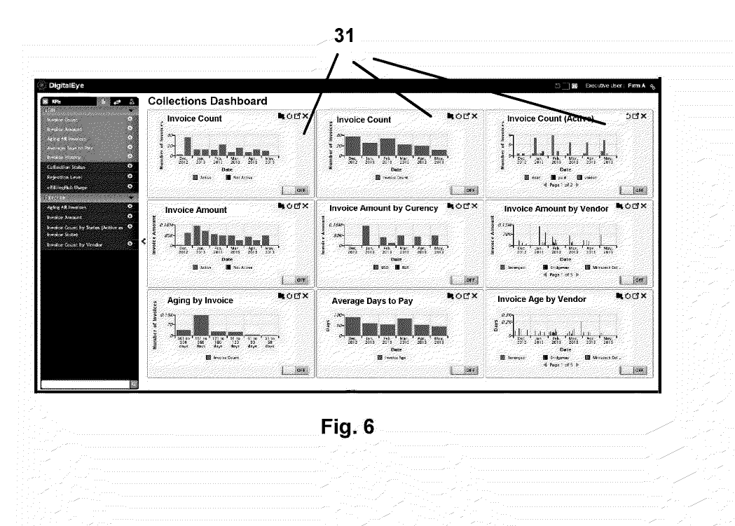

FIG. 2 depicts the preferred radial menu 14 of the system 10. This radially depicted menu 14 of icons or depictions 15 relating to user choices for underlying data to be communicated, can lead to underlying additional radial menus 14, or may provide the graphic interface for the user to choose the data for communication to their device, to yield the graphic depictions thereon of for instance FIG. 1 or FIG. 6. Thus the user can be presented with icons or depictions 15 representing choices for drill down 17 or filters 19 which can be presented on a sequential radial menu 14 offering the user depictions 15 or icons which using a pointing device such as a mouse can cursor allow choices for even deeper drill down 17 options, or a communication of available data concerning key performance indicators available for the depiction 15 relating to the data chosen by the user.

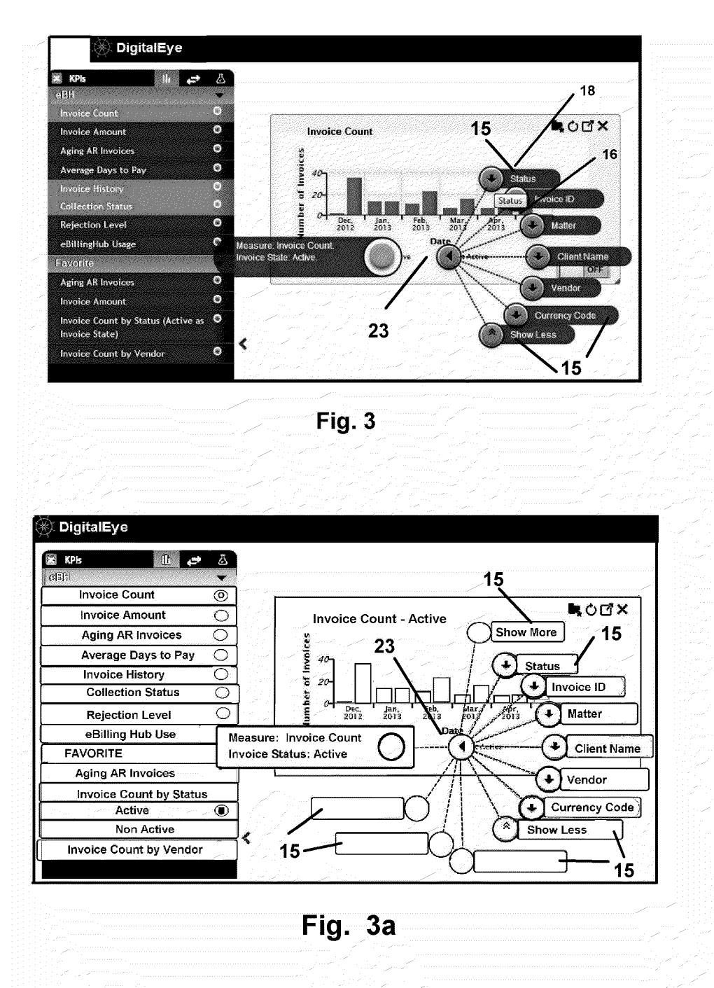

FIG. 3 is an example of a depiction of the communicated interface to a user display offering a response to a drilldown 17 choice from an earlier action by the user to depicted icons or depictions 15. Individual key data indicators available are offered in the preferred radial view of depictions 15 or icons in the system 10 described herein. Preferably the radially depictions 15 representing user available choices extend radially around a center area 23 of the screen such that on large and very small screens the user is presented with “clickable” choices, each of which will provide a choice for a subsequent communication of data to the user device.

FIG. 3a shows the advantages of the radial depiction of choices to a user showing the screen-centering and lines associating the available data with the prior chosen request which for example is a request for information available concerning active invoices. The radial positioning of graphic interface offering the plurality of choices of data yielding indicators related to the prior choice provides for a display on small and large computer engaged displays which is intuitive and easily navigated by novices and experts alike, to choose the data for communication to the user device desired.

FIG. 4 shows a simple grid style view 20 of communicated data chosen from the radial interface of FIGS. 3 and 3a, displayed on the local display subsequent to choosing the data to be communicated. If data concerning a single KPI for instance has been chosen, the system might by default communicate the data and underlying support data in the side by side depiction of FIG. 4.

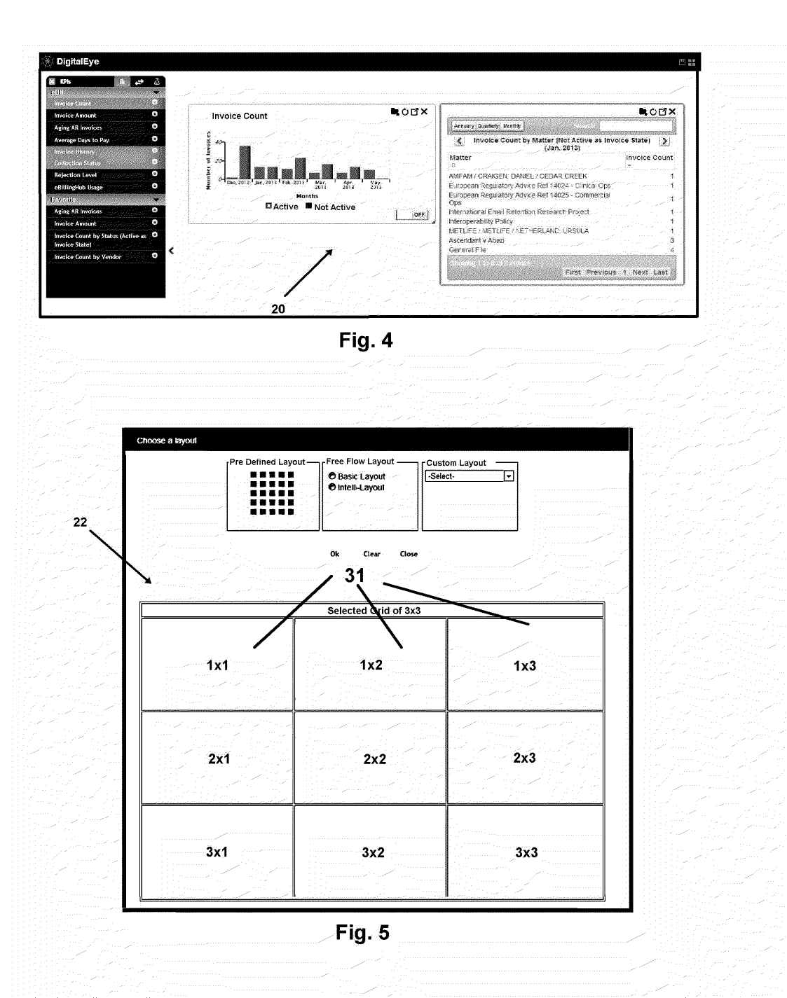

FIG. 5 depicts a grid creation graphic interface 22 of the system 10 described herein. Such may be provided to the user before making data communication request for KPI data using the radial interface of FIGS. 3 and 3a, or may be presented afterward and take into consideration how many individual KPI data communications have been requested. For instance if the user has to request data be communicated concerning nine different KPI's, the user may employ the graphic interface 22 to choose a depiction locally, for the data concerning each KPI in individual rectangular portions 31 of a grid as in FIG. 6.

Further using a pointing device and cursor, the user can drag and drop the depicted graphic KPI information shown for instance in FIG. 6, to different rectangular portions by graphically dragging the depiction 15 to an individual or different rectangular section 31. Thus, the user is afforded with a drag and drop ability to move the relational KPI depictions, yielded from the request using the radial interface of FIGS. 3 and 3a for example, to any position on the grid formed. This allows the user great flexibility in the final presentation of the graphic depictions of the data concerning the individual KPI's chosen from the radial interface in prior actions.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A software program configured to operate on a computer in communication with a network to provide a graphical user interface for creating, manipulating and displaying depictions of user chosen data, comprising:
a graphic interface communicable over said network to a user display;
said graphic interface depicting a plurality of individual depictions relating to respective user choices to initiate a data communication to said user device, or to initiate secondary depictions relating to one or a plurality of sub choices available to said user, to said user display engaged with a local computing device;
said plurality of individual depictions relating to choices communicated to said user display positioned in a central portion of said user display in a radial positioning of said depictions relating to individual choices around a central position; and
whereby said user may employ an input device operatively engaged with said local computing device to interact with said graphical interface communicated to said user display, to communicate a choice of one or a plurality of said user choices depicted in said radial positioning of said depictions, and thereby either elicit a communication of said data relating to each respective user choice, or to communicate said secondary depictions relating to one or a plurality of sub choices available to said user.

2. The graphic interface of claim 1, additionally comprising:
a secondary graphic interface communicable over said network to a user display, said secondary graphic interface providing a user selectable grid selection, of a number and positioning of individual areas in which to display graphic depictions of said data communicated to said user device, as a result of a said choice by said user.

3. The graphic interface of claim 2, additionally comprising:
said secondary graphic interface configured to allow said user using said pointing device to drag and drop said depictions of said data communicated to said user device, to any of said individual areas.

4. The graphic interface of claim 2, additionally comprising:
said secondary depictions relating to one or a plurality of sub choices available to said user being communicated to said user display electronically for positioning said central portion of said user display in a said radial positioning of said secondary depictions relating to said individual sub choices around a said central position; and
whereby said user may employ said input device operatively engaged with said local computing device to interact with said secondary depictions of said graphical interface communicated to said user display, to communicate one or a plurality of said user choices from those depicted said radial positioning of said secondary depictions, and thereby either elicit a communication of said data relating to each respective user choice from said secondary depictions, or elicit a communication of one or a plurality of secondary sub choices available to said user.

5. The graphic interface of claim 4, additionally comprising:
a secondary graphic interface communicable over said network to a user display, said secondary graphic interface providing a user selectable grid selection of a number and positioning of individual areas in which to display graphic depictions of said data communicated to said user device, as a result of a said choice by said user of said secondary depictions.

6. The graphic interface of claim 5, additionally comprising:
said secondary graphic interface configured to allow said user using said pointing device to drag and drop said depictions of said data communicated to said user device, to any of said individual areas.
